(19) United States
(12) Patent Application Publication
(10) Pub. No.: US 2005/0218678 A1
(43) Pub. Date: Oct. 6, 2005

(54) Autonomous device for the magnetic handling of an electronic component

(75) Inventor: Alexis De Bibikoff, Andilly (FR)

Correspondence Address: WESTMAN CHAMPLIN & KELLY, P.A., SUITE 1600 - INTERNATIONAL CENTRE, 900 SECOND AVENUE SOUTH, MINNEAPOLIS, MN, 55402-3319, US

(73) Assignee: Wavecom, Issy-Les-Moulineaux, Cedex (FR)

(21) Appl. No.: 10/512,350

(22) PCT Filed: Apr. 22, 2003
(86) PCT No.: PCT/FR03/01277

§ 371 Date: Apr. 29, 2005

(30) Foreign Application Priority Data
Apr. 22, 2002 (FR) 02/05027

(51) Int. Cl. B25J 15/06

(52) U.S. Cl. 294/65.5

(57) ABSTRACT

The invention relates to an autonomous device that is used to handle an electronic component (1), comprising a body (2) and head (3) for picking up said component (1) magnetically. Moreover, the aforementioned pick-up head (3) comprises a permanent magnet (4) and mechanical separation means which can move in relation to one another such that the device can occupy at least two positions, namely: a pick-up position, in which the magnet (4) interacts with the component (1) so as to keep said component in contact with a contact surface of the head (3); and a release position, in which the magnet (4) is moved away from the component (1) such as to stop the magnetic interaction.

The invention is in the field of handling electronic components, notably with the purpose of fitting them or replacing them onto a printed circuit. More precisely, the invention relates to tools with a grip head allowing to grasp and move such a component.

Applications of the invention lie in numerous fields, such as telecommunications, wireless data transfer, automobile, electronics, embedded electronics, electronic and component transfer industry, chemical industry, laboratories and medical sector.

The expression “electronic component” here means every type of component likely to be handled, with care and precision, notably without deterioration during implementation. In particular, they are components with pins, on their surface and/or periphery, that are to be brazed onto printed circuits.

They can for example be standard components (microprocessors, memory strips . . . ), hybrid components, CMS components, macro-components.

The expression “macro-component” here means devices uniting, in a single box (generally creating a shield) intended to be fitted to a printed circuit, several components. Such macro-components are notably disclosed in the patent FR-0002069 under the name of the holder of this application, and distributed by the latter under the WISMO brand.

Components can have several hundred pins.

The increase in this number, linked to the demands for miniaturisation, obviously requires that the pins are very small, and that the space between them is very restricted. Thus, it is not uncommon for the thickness of a pin to be approximately 0.4 mm.

Of course each of these pins must not be damaged, broken or displaced. Notably, it is essential that the pins of these components have a very precise flatness between them at the time of assembling them with the printed circuit. By way of example, the required precision regarding the flatness of the pins is normally about 0.1 mm.

Such a requirement is notably linked to the fact that, in the case of a defect in the flatness of the pins, the shortest pins would not touch the copper track of the printed circuit via the brazing paste, the thickness of the track and the paste being invariable. This is, of course, unacceptable.

Moreover, the thickness of the component is generally ensured with a precision of about 0.1 mm, which implies that the pins have the same precision regarding their flatness.

The fineness of these pins, and therefore their brittleness, associated with the aforementioned requirements, consequently render the handling of such components very delicate.

It is therefore unthinkable to consider handling these components manually, due to the risk of deforming the pins, which moreover tend to become thinner and thinner.

Moreover, manual handling would generate an oxidation of the components.

Several non-manual techniques have therefore been proposed for the handling of such components.

We notably know of a technique, according to which the gripping of the components is obtained via mechanical clamping of the components with the use of inverted or non-inverted classic pliers or tweezers.

This technique implies picking up the component by its edges, which is not always possible depending on the position of the pins.

Moreover, such mechanical clamping does not allow for high precision. There is therefore a major risk of deterioration, in particular in the case of macro-components whose pins have a thickness of 0.4 mm.

We also know of a technique, commonly used in microelectronics, according to which the gripping of the components is ensured via suction. In this case, a draw-off pipette fitted on one end with a sucker is usually used to draw up the component, the vacuum being maintained through covering, with a finger, a hole in the pipette, whereas the component is released by removing the finger from the hole.

However, such suction is only possible when the component has a perfectly flat and impervious surface. Yet, this condition is not always met, notably in the case of components or macro-components with metal shielding caps, the latter having degassing holes engendering a risk of loss of vacuum, and therefore the dropping of the component whilst being handled. In some cases, the number and/or the location of these degassing holes makes the suction of the component impossible.

Moreover, the draw-off pipette must be connected to a vacuum centre, implying the implementation of connecting means between the pipette and the centre. Such means have proved to be very restrictive, whether that be during the installing of the equipment or during the handling of the components.

Autonomous suction tools have been proposed, but these are only applicable to small CMS components.

Furthermore, we know of a gripping technique using a magnetic field. According to this technique, the tool has an electromagnet fitted to one of its ends allowing to maintain the component via a magnet field.

However, the principle of the electromagnet implies an electric connection to a power plant; the tool is therefore not autonomous. Furthermore, it is relatively costly and bulky.

There also exist tools fitted with a permanent magnet. These tools are specifically intended for extraction or separation applications, and do not allow precise handling. Indeed, the components picked up by the magnetic tool must be manually separated from the latter. Yet, such a manual intervention is unthinkable for the aforementioned reasons as it concerns electronic components or macro-components.

The purpose of the invention is to overcome these inconveniences of the prior art.

More precisely, the purpose of the invention is to propose a device for handling electronic components which is autonomous and which does not imply any direct manual intervention on the component.

The expression “autonomous” notably means that the device does not need to be connected to a power supply or a vacuum centre as is the case for the prior solutions. The purpose is therefore that the device is light, movable, transportable, usable in all circumstances and independent of an energy source (electric, vacuum . . . ).

The invention also has the purpose of supplying such a handling device which allows to handle fragile and sensitive electronic components or macro-components with high precision, without damaging their pins.

Notably, such a device must not affect the flatness of the pins of the component.

The invention also has the purpose of supplying such a handling device which is not bulky, allowing it to be used in confined environments such as test cages with small openings.

Another purpose of the invention is to supply such a handling device that is light and practical to use.

Yet another purpose of the invention is to supply such a handling device that is of simple design, ease to assemble and implement, and whose manufacturing costs are low.

These objectives and others which will be developed later on, are reached thanks to the invention which relates to a autonomous device for handling electronic components, bearing a body and a head for gripping said component via magnetism, characterised in that said grip head comprises a permanent magnet and mechanical separating means, movable one from the other in such a way that said device can have at least two positions:
a gripping position, in which said magnet interacts with said component, so as to hold it in contact with a contact area of said head;
a releasing position, in which said magnet is at a distance from said component, so as to break the magnetic attraction.

Thus thanks to the invention, we have a tool that integrates means for gripping the component without the risk of deteriorating it and means for releasing the component without direct manual intervention on the component.

Moreover, these advantages are obtained whilst ensuring the autonomous aspect of the device, the latter not being connected to any vacuum centre or power supply, contrary to the solutions of the prior art.

According to a first embodiment, said mechanical means for separating are movable along said magnet, and, when moving from said gripping position to said releasing position, they exercise a thrust on said component so as to release it from said magnetic attraction.

In this case, said magnet is hollow, said mechanical means for separating being mounted so as to slide along the latter.

According to a second embodiment, said magnet is movable in relation to said head, and, in:
said gripping position, said magnet is near to a contact area created at the far end of said head;
said releasing position, said magnet is at a distance from said contact area, so as to release said component from said magnetic attraction.

This embodiment allows to obtain high precision.

Indeed, the contact area, which creates a stop for the component during the retraction of the magnet, is fixed. Thus, the precise positioning of this contact area precisely corresponds to the position in which the component is released from the magnetic attraction, the component having been previously moved to the desired location.

Preferably, in said releasing position, said component stops against said contact area.

Advantageously, in this case, said grip head comprises a hollow body whose open end creates said contact area, and in which said magnet is mounted so as to slide.

We thus obtain an ergonomic tool. Of course, other embodiments are conceivable, as the magnet can for example have the shape of a hollow cylinder sliding around a fixed part of the device whose end would also create a contact area with, the component when the magnet is retracting.

In either of the embodiments, the device advantageously comprises means for actuating a relative movement between said magnet and said mechanical means for separating.

According to a first approach, said means for actuating provoke the displacement of said magnet to said retracting position.

In this way, the releasing of the component is obtained via the controlling of the means for actuating.

According to a second approach, said means for actuating provoke the displacement of said magnet to said gripping position.

Contrary to the previous case, the controlling of the means for actuating results in the gripping of the component.

According to one or other of the two approaches, the device preferably comprises means of elastic return acting on said magnet and/or on said means for separating so as to return said device to the position it takes when there is no control of said means for actuating.

According to a preferred solution, said means of elastic return act on said magnet so as to place said device in said gripping position.

According to an advantageous solution, said means of elastic return comprise at least one conical spring. Indeed, such a spring takes up very little space and can easily be inserted into a small device.

According to a preferred solution, said means for actuating are controlled via a trigger located on said body.

In this case, said body and said grip head create an angled single unit. According to an alternative, said grip head is swivel mounted on said body.

According to an advantageous solution, said grip head has, opposite said open end, an outgrowth extending into the extension of said hollow body.

In this manner we can increase the retraction distance of the magnet. Indeed, such a feature can prove to be useful depending on the magnetic attraction of the magnet, knowing that the latter, in the releasing position, must preferably be less than 10% of the weight of the component. In other terms, greater the retraction distance of the magnet weaker the magnetic attraction likely to affect the component.

Advantageously, said body is telescopic.

According to a preferred solution, said magnet and/or said contact area is coated with a membrane, for example in flexible plastic or rubber.

Other features and advantages of the invention will become clearer upon reading the description of two preferred embodiments of the invention, given by way of non-restrictive examples, and of the annexed drawings, among which:

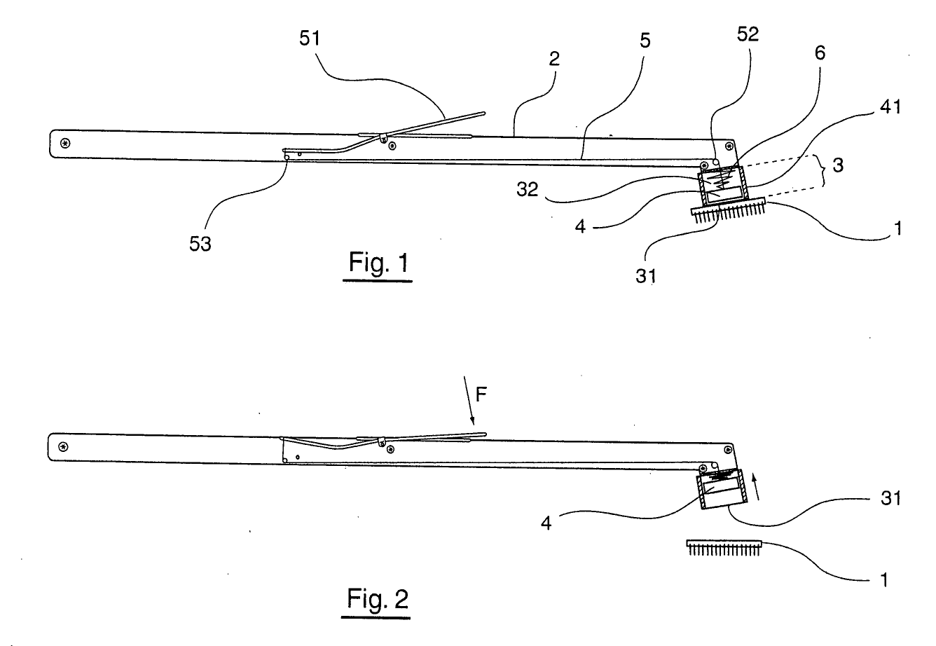

FIG. 1 is an overall view of an autonomous device for handling an electronic component according to the invention, in a configuration corresponding to a gripping position;

FIG. 2 is an overall view of the device in FIG. 1, in a configuration corresponding to a releasing position;

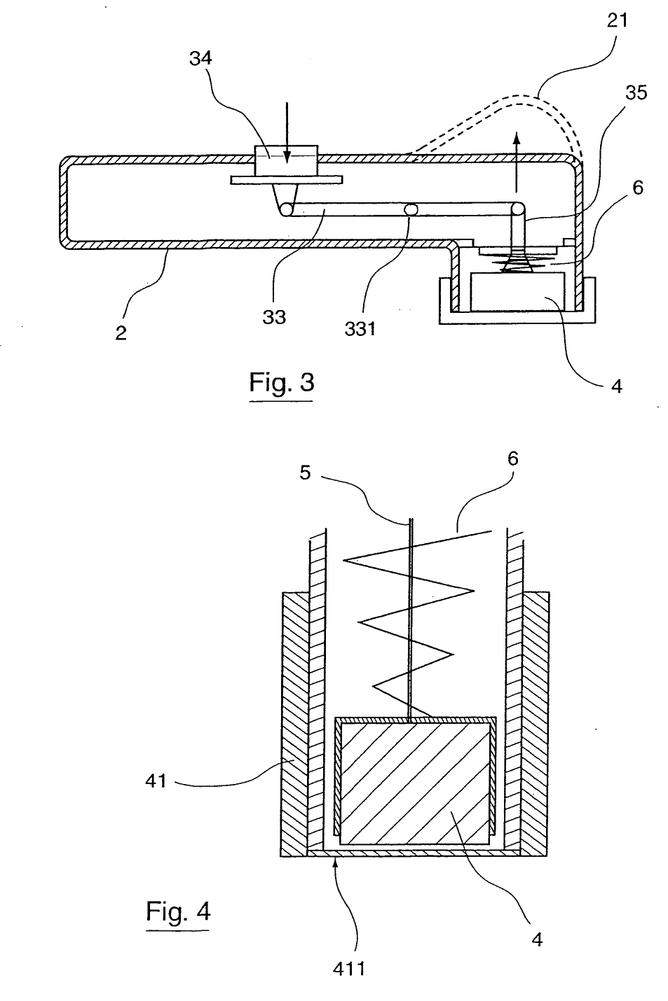

FIG. 3 is a view of a second embodiment of the invention;

FIG. 4 is a detailed view of the grip head of a device according to the invention.

The invention therefore relates to an autonomous device for handling components, implementing a permanent magnet and mechanical means allowing to separate the magnet and the component with high precision and without any manual contact with the latter.

FIGS. 1 and 2 show an example of such a device, respectively in the gripping and releasing positions.

The autonomous device for handling an electronic component 1 comprises a body 2 and a grip head. 3 attached to each other.

In FIGS. 1 and 2, we notice that the body 2 and the grip head create an angled single unit, constituted for example of two plastic half shell split structures attached to each other. However, according to another conceivable embodiment, the head can be swivel mounted on the body of the device.

It is also conceivable that the body and the grip head extend in a coaxial manner.

We also notice that, according to a conceivable alternative, adaptable to the different aforementioned cases, the body 2 of the device can be designed to make it telescopic.

According to the invention, the grip head 3 comprises a permanent magnet 4 and mechanical separating means, movable one from the other in such a way that said device can take the positions illustrated in FIGS. 1 and 2.

The dimension as well as the material of the magnet 4 are designed so that the latter can support from 3 to 5 times the weight of the component.

By way of example, for a WISMO 3A type macro-component weighing 11 grams, the magnet is therefore designed so that its magnetic attraction can hold a weight of between 33 and 55 grams.

As illustrated in FIG. 1, the device takes a gripping position in which the magnet 4 has a magnetic attraction to the component, holding it in contact with the grip head 3.

FIG. 2 illustrates the device in the releasing position, in which the magnet 4 is distanced from the component 1, so as to break the magnetic attraction to the component.

According to this embodiment, the magnet 4 is movable in relation to the grip head 3 between the gripping position, in which it is near to a contact area 31 of the head 3, and the releasing position, in which it is distanced from this contact area 31 whereas the component 1 is stopped against the latter.

To accomplish this, the magnet 4 is slide mounted in the hollow body 32 of the grip head 3, the open end of this hollow body 32 creating the contact area 31 against which the component 1 is likely to stop.

It can be envisaged that the magnet is mounted in a support, the latter thus sliding in the hollow body of the grip head.

It can be understood that the contact area 31 thus creates the means for separating according to the invention, as, during retraction of the magnet 4 in the hollow body 32 of the head 3, the area 31 holds the component in a fixed position whereas the magnet moves away from the component until the magnetic attraction is insufficient to hold the component.

In the releasing position of the device, the magnetic attraction likely to interact with the component depends on the intrinsic magnetic attraction of the magnet, but also on how distant the latter is from the far end of the grip head. According to a particular embodiment, the grip head can have, opposite its open end, an elongation extending in the continuity of the hollow body, so as to allow for a greater distance between the magnet in the retracting position and the open end of the head.

Practically, it is aimed to make the force resulting from the magnetic attraction of the magnet in the releasing position less than 10% of the weight of the component, which, for a WISMO 3A type macro-component as aforementioned, corresponds to a force less than that which holds a weight of 1.1 grams.

The means for actuating the movement of the magnet are constituted of a nylon wire 5 attached at one of its ends to the magnet 4, and at its other end to a trigger 51, swivel mounted onto the body 2 of the device.

This nylon wire 5 is deviated, from the magnet 4, by a first axis 52 acting as a pulley near the magnet, then by a second axis 53, also acting as a pulley near the trigger 51.

Such an assembly of the wire 5 in the device engenders a displacement of the magnet to the releasing position when a force F is applied to the trigger 4, such as illustrated in FIG. 2.

It can be noticed that the nylon wire can be made in other materials, or be replaced by a system of rigid rods, springs, bars and/or any other known means allowing to displace a movable part, in other embodiments. In the case where the body of the device is telescopic, the nylon wire (or other conceivable means) is extensible so as to adapt to length variations of such a body.

It can be also noticed that according to an inverse approach, the assembly of the means for actuating can be designed so as to displace the magnet to a gripping position when a force is applied to the trigger.

According to the present embodiment, the device comprises means of elastic return 6 acting on the magnet 4 so as to return the latter to the gripping position when there is no action on the trigger 51. These means of elastic return are here constituted of a conical spring, which has the advantage of using very little space (about 0.1 mm) in the compressed state, as illustrated in FIG. 2.

Furthermore, as illustrated in FIG. 4, it is envisaged to endow the grip head with a stopper 4 bearing at its end a membrane 411, notably with the aim of:
constituting a sort of impervious joint avoiding the depositing of metallic particles on the magnet;
avoiding the deterioration of the component when in contact with the magnet, which could for example engender scratches;
constituting a gap allowing to locally reduce the magnetic field on the component, thus avoiding a permanent magnetisation of the component.

This membrane 41 is made in plastic or rubber, with a thickness of between 0.1 mm and 0.5 mm.

In reference to FIG. 3, which illustrates a second embodiment of the invention, the mechanism for actuating the movement of the magnet is constituted of an articulated rod 33 swivel mounted on the body 2 around an axis 331.

This articulated rod 33 is swivel mounted on one of its ends onto a push button 34, and articulated, at its other end, onto a shank 35 attached to the magnet 4.

As previously detailed, the grip head of the device can have an elongation 21 (represented by dotted lines), to allow for an increase in the retraction distance from the magnet 4 on the inside of the grip head.

According to one or other of the embodiments which have just been disclosed, the assembling of such a device is, by way of example, performed by carrying out the following stages:
melt the end of the nylon wire so as to create a small ball;
cut the nylon wire to a set length;
thread the wire through the spring and a magnet support (pierced through its centre);
bond the magnet to its support by wedging the end of the wire to the inside of the support and by fixing the final length of the wire;
place the axes in one of the half shell structures of the body;
place the magnet-support-spring-wire-trigger unit in the half shell structure starting from the magnet side, then, by holding the spring down, place the trigger in its axis;
place the second half shell structure onto the first, whilst holding the spring down;
screw the two half shell structures together.

1-18. (canceled)

19. An autonomous and adjustable device for handling an electronic component, the device comprising:
a bearing a body; and
a head for gripping said component via magnetism, wherein said grip head is swivel mounted on said body and comprises a permanent magnet and mechanical separating means, movable one from the other in such a way that said device can have at least two positions:
a gripping position, in which said magnet interacts with said component, so as to hold it in contact with a contact area of said head; and
a releasing position, in which said magnet is at a distance from said component, so as to break the magnetic attraction, and wherein said body is telescopic.

20. The autonomous handling device set forth in claim 19, wherein said mechanical means for separating are movable along said magnet, and wherein, when moving from said gripping position to said releasing position, said mechanical means exercise a thrust on said component so as to release it from said magnetic interaction.

21. The autonomous handling device set forth in claim 20, wherein said magnet is hollow, said mechanical means for separating being mounted so as to slide along the latter.

22. The autonomous handling device set forth in claim 19, wherein said magnet is movable in relation to said head, and wherein, in:
said gripping position, said magnet is near to a contact area created at a far end of said head; and
said releasing position, said magnet is distanced from said contact area, so as to release said component from said magnetic interaction.

23. The autonomous handling device set forth in claim 22, wherein, in said releasing position, said component stops against said contact area.

24. The autonomous handling device set forth in claim 22, wherein said grip head comprises a hollow body whose open end creates said contact area, and in which said magnet is mounted so as to slide.

25. The autonomous handling device set forth in claim 19, wherein the device comprises means for actuating a relative movement between said magnet and said mechanical means for separating.

26. The autonomous handling device set forth in claim 25, wherein said means for actuating provoke the displacement of said magnet to said releasing position.

27. The autonomous handling device set forth in claim 25 wherein said means for actuating provoke the displacement of said magnet to said gripping position.

28. The autonomous handling device set forth in claim 19 and further comprising means of elastic return acting on said magnet and/or on said means for separating so as to return said device to the position it takes when there is no control of said means for actuating.

29. The autonomous handling device set forth in claim 28, wherein said means of elastic return act on said magnet so as to place said device in said gripping position.

30. The autonomous handling device set forth in claim 28 wherein said means of elastic return comprise at least one conical spring.

31. The autonomous handling device set forth in claim 25, wherein said means for actuating are controlled via a trigger located on said body.

32. The autonomous handling device set forth in claim 19, wherein said grip head has, opposite said open end, an elongation extending into the continuity of said hollow body.

33. The autonomous handing device set forth in claim 1, wherein said magnet and/or said contact area is coated with a membrane.
